(19) United States
(12) Patent Application Publication
(10) Pub. No.: US 2006/0150684 A1
(43) Pub. Date: Jul. 13, 2006

(54) Composite mold and method for making the same

(75) Inventor: Charles Leu, Fremont, CA (US)

Correspondence Address: MORRIS MANNING & MARTIN LLP, 1600 ATLANTA FINANCIAL CENTER, 3343 PEACHTREE ROAD, NE, ATLANTA, GA, 30326-1044, US

(73) Assignee: HON HAI Precision Industry CO., LTD., Tu-Cheng City (TW)

(21) Appl. No.: 11/321,318

(22) Filed: Dec. 29, 2005

(30) Foreign Application Priority Data
Jan. 7, 2005 (CN) 200510032759.9

(51) Int. Cl. C03B 40/02; C03B 9/48; C22C 5/00

(52) U.S. Cl. 65/170; 65/374.12; 75/247; 75/747

(57) ABSTRACT

A composite mold includes a porous mold base and a lubricant filled in the porous mold base. The porous mold base includes at least a first portion, which includes a sintered material formed by sintering noble metal particles and tungsten carbide particles. A molding surface of the porous mold base is defined on the first portion. Preferably, the porous mold base further includes a second portion. The second portion of the mold base is integrally formed with the first portion, and is located distal from the molding surface. The second portion of the mold base is made of a sintered material formed by sintering tungsten carbide particles. Alternatively, the second portion, like the first portion, is made of a sintered material formed by sintering noble metal particles and tungsten carbide particles. A method for making a composite mold is also provided.

### TECHNICAL FIELD

The present invention relates to a mold for molding glass articles, and more particularly relates to a composite mold and a method for making the mold.

### BACKGROUND

Glass optical articles, such as aspheric lenses, ball-shaped lenses, prisms, etc. are generally made by a direct press-molding process using a mold. The glass optical articles obtained by the direct press-molding method advantageously do not need to undergo further processing, such as a polishing process. Accordingly, the manufacturing efficiency can be greatly increased. However, the mold used in the direct press-molding method has to satisfy certain critical requirements such as high chemical stability, resistance to heat shock, good mechanical strength, and good surface smoothness.

Several criteria that should be considered in choosing the material for making the mold are listed below:
a. the mold formed from such material is rigid and hard enough so that the mold cannot be damaged by scratching and can withstand high temperatures;
b. the mold formed from such material is highly resistant to deformation or cracking even after repeated heat shock;
c. the mold formed from such material does not react with or adhere to the glass material at high temperatures;
d. the material is highly resistant to oxidization at high temperatures;
e. the mold formed of such material has good machinability, high precision, and a smooth molding surface; and
f. the manufacturing process using the mold is cost-effective.

In earlier years, the mold was usually made of stainless steel or a heat resistant metallic alloy. However, such mold typically has the following defects. Sizes of crystal grains of the mold material gradually become larger and larger over a period of time of usage, whereby the surface of the mold becomes more and more rough. In addition, the mold material is prone to being oxidized at high temperatures. Furthermore, the glass material tends to adhere to the molding surface of the mold.

Therefore, non-metallic materials and super hard metallic alloys have been developed for making molds. Such materials and alloys include silicon carbide (SiC), silicon nitride (Si₃N₄), titanium carbide (TiC), tungsten carbide (WC), and a tungsten carbide-cobalt (WC—Co) metallic alloy. However, SiC, Si₃N₄ and TiC are ultrahard ceramic materials. It is difficult to form such materials into a desired shape, especially an aspheric shape, with high precision. Further, WC and a WC—Co alloy are liable to be oxidized at high temperatures. All in all, these materials are not suitable for making high-precision molds.

Thus, a composite mold comprising a mold base and a protective film formed thereon has been developed. The mold base is generally made of a carbide material or a hard metallic alloy. The protective film is usually formed on a molding surface of the mold base.

Typically, the mold base of the composite mold is made of a hard metallic alloy, a carbide ceramic, or a metallic ceramic. The protective film of the composite mold is formed of a material selected from the group consisting of iridium (Ir), ruthenium (Ru), an alloy of Ir, platinum (Pt), rhenium (Re), osmium (Os), rhodium (Rh), and an alloy of Ru, Pt, Re, Os and Rh.

However, the mold base of the such composite mold has an unduly high hardness. Therefore a molding surface of the composite mold has to be machined by a diamond cutting tool, and the process for making the mold is unduly complex. In addition, the surface smoothness of the mold is relatively low, which may impair the workpiece release performance.

Therefore, a mold with good workpiece release performance and a simple method for making such a mold are desired.

### SUMMARY

A composite mold comprises a porous mold base and a lubricant filled in the porous mold base. The porous mold base has a first portion comprised of a sintered material formed by sintering noble metal particles and tungsten carbide particles. A molding surface of the porous mold base is defined on the first portion.

Preferably, the porous mold base further has a second portion. The second portion of the porous mold base is integrally formed with the first portion, and is located distal from the molding surface. The second portion of the porous mold base is made of a sintered material formed by sintering tungsten carbide particles. Alternatively, the second portion, like the first portion, is made of a sintered material formed by sintering noble metal particles and tungsten carbide particles.

A percentage by weight of the noble metal particles in the sintered material is generally configured to be in the range from 1% to 25%, and preferably in the range from 1% to 13%. The noble metal particles may be selected from the group consisting of Pt, Re, PtₘRhₙ alloy, ReₓIr_{y} alloy, and PtₘIrₙ alloy; wherein, x is in the range from 0.25 to 0.55, y is in the range from 0.45 to 0.75, and m and n satisfy the following conditions: m+n=100, and 10<m<90. The lubricant may be selected from the group consisting of mineral oil, animal oil, and vegetable oil.

A method for making a composite mold comprises the steps of: providing a first mold having a desired shape; placing a mixture of noble metal particles and tungsten carbide particles into the first mold; forming a porous mold base having a molding surface by sintering the mixture of noble metal particles and tungsten carbide particles; and filling the porous mold base with a lubricant by immersing the porous mold base in the lubricant. The first mold is made of a hard metallic alloy. A percentage by weight of the noble metal particles in the sintered material is generally configured to be in the range from 1% to 25%, and preferably in the range from 1% to 13%. The particle sizes of the noble metal particles and tungsten carbide particles are in the range from 1 nm to 100 nm. The noble metal particles may be selected from the group consisting of Pt, Re, PtₘRhₙ alloy, ReₓIr_{y} alloy, and PtₘIrₙ alloy; wherein, x is in the range from 0.25 to 0.55, y is in the range from 0.45 to 0.75, and m and n satisfy the following conditions: m+n=100, and 10<m<90. Preferably, the noble metal particles are placed adjacent a surface of the first mold corresponding to the molding surface of the porous mold base. The lubricant may be selected from the group consisting of mineral oil, animal oil, and vegetable oil.

The porous mold base has a composite structure made of a sintered material formed by sintering noble metal particles and tungsten carbide particles. Therefore the porous mold base has high hardness, and the molding surface of the porous mold base has good surface smoothness. Furthermore, due to the lubricant filled in the porous mold base, the following advantages are obtained. The lubricant can be released during a molding process, thereby forming a mold release agent on the molding surface. Thus a separate step of adding a mold release agent on the molding surface is not needed, and the molding process is simplified.

Other advantages and novel features will become more apparent from the following detailed description when taken in conjunction with the accompanying drawings.

### BRIEF DESCRIPTION OF THE DRAWINGS

Many aspects of a composite mold and a method for making the same can be better understood with reference to the following drawings. The components in the drawings are not necessarily to scale, the emphasis instead being placed upon clearly illustrating the principles of the composite mold and the method for making the same. Moreover, in the drawings, like reference numerals designate corresponding parts throughout the several views.

FIG. 1 is a schematic, cross-sectional view of a composite mold in accordance with a first embodiment of the present invention.

FIG. 2 is an enlarged, schematic, cross-sectional view of a molding surface portion of the composite mold of FIG. 1.

FIG. 3 is a schematic, cross-sectional view of a composite mold in accordance with a second embodiment of the present invention.

### DETAILED DESCRIPTION OF THE EMBODIMENTS

The present invention is further described below including by reference to the figures.

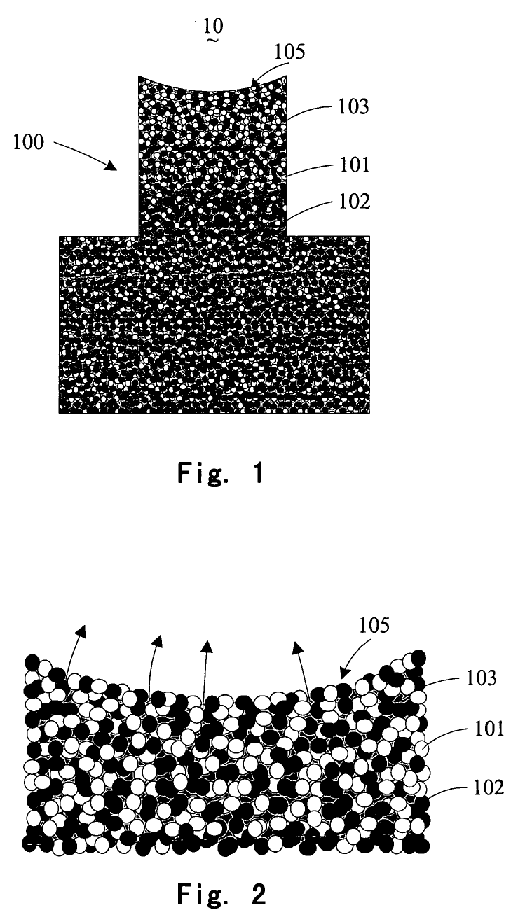

Referring to FIG. 1 and FIG. 2, a composite mold according to a first embodiment of the present invention is shown. The composite mold 10 is for molding a glass article, for example a glass optical lens. The composite mold 10 comprises a porous mold base 100 having a molding surface 105, and a lubricant 103 filled in the porous mold base 100. The porous mold base 100 is made of a sintered material formed by sintering noble metal particles 101 and tungsten carbide particles 102.

A percentage by weight of the noble metal particles 101 in the sintered material is generally configured to be in the range from 1% to 25%, and preferably in the range from 1% to 13%. The noble metal particles 101 may be selected from the group consisting of Pt, Re, PtₘRhₙ alloy, ReₓIr_{y} alloy, and PtₘIrₙ alloy; wherein, x is in the range from 0.25 to 0.55, y is in the range from 0.45 to 0.75, and m and n satisfy the following conditions: m+n=100, and 10<m<90. The lubricant 103 may be selected from the group consisting of mineral oil, animal oil, and vegetable oil, such as machine oil, organosilane, etc.

Referring to FIG. 2, during a molding process, the lubricant 103 can be released from the porous mold base 100 by molding pressures and high temperature, as shown by the arrows. Thereby, a mold release agent is formed on the molding surface 105.

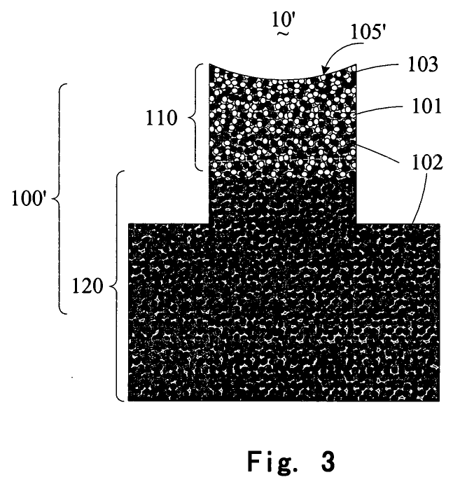

Referring to FIG. 3, a composite mold according to a second embodiment of the present invention is shown. The composite mold 10′ is for molding a glass article, for example a glass optical lens. The composite mold 10′ comprises a porous mold base 100′ having a molding surface 105′, and a lubricant 103 filled in the porous mold base 100′. The composite mold 10′ is similar to the composite mold 10 of the first embodiment. However, the porous mold base 100′ comprises a first portion 110 having the molding surface 105′ thereon, and a second portion 120. The second portion 120 is integrally formed with the first portion 110, and is located distal from the molding surface 105′. The first portion 110 is made of a sintered material formed by sintering the noble metal particles 101 and the tungsten carbide particles 102, while the second portion 120 is made of a sintered material formed by sintering tungsten carbide particles 102.

Referring to FIG. 1, a first method for making a composite mold such as the composite mold 10 is provided. The first method comprises the steps of:
(a) providing a first mold, the first mold having a desired shape;
(b) placing a mixture of noble metal particles 101 and tungsten carbide particles 102 into the first mold;
(c) applying a pressing force so as to compress the noble metal particles 101 and tungsten carbide particles 102 to be tightly held together;
(d) sintering the mixture of the noble metal particles 101 and tungsten carbide particles 102, thereby forming a porous mold base 100 having a molding surface; and
(e) filling up the porous mold base 100 with a lubricant 103 by immersing the porous mold base 100 in the lubricant 103.

The first mold is made of a hard metallic alloy. A percentage by weight of the noble metal particles 101 in the mixture is generally configured to be in the range from 1% to 25%, and preferably in the range from 1% to 13%. The particle sizes of the noble metal particles 101 and tungsten carbide particles 102 are in the range from 1 nm to 100 nm. The noble metal particles 101 may be selected from the group consisting of Pt, Re, PtₘRhₙ alloy, ReₓIr_{y} alloy, and PtₘIrₙ alloy; wherein, x is in the range from 0.25 to 0.55, y is in the range from 0.45 to 0.75, and m and n satisfy the following conditions: m+n=100, and 10<m<90. The lubricant 103 may be selected from the group consisting of mineral oil, animal oil, and vegetable oil, such as machine oil, organosilane, etc.

Referring to FIG. 3, a second method for making a composite mold such as the composite mold 10′ is provided. The second method is similar to the first method described above. However, in step (b) of the second method, the tungsten carbide particles 102 are placed into the first mold, and are utilized as the material for forming the second portion 120 of the porous mold base 100′. In addition, a mixture of noble metal particles 101 and tungsten carbide particles 102 is then placed into the first mold, and is utilized as the material for forming the first portion 110 of the porous mold base 100′.

The porous mold base of the composite mold has characteristics of high hardness and high mechanical strength, and ability to endure stresses at high temperatures. Because the porous mold base is formed of noble metal materials, the molding surface has good surface smoothness and good workpiece release performance. This means that a production yield of glass products having satisfactory quality can be improved. Furthermore, due to the lubricant filled in the porous mold base, the following advantages are obtained. The lubricant can be released during a molding process, thereby forming a mold release agent on the molding surface. Thus an additional step of adding a mold release agent on the molding surface is not needed, and the molding process is simplified.

It is believed that the present embodiments and their advantages will be understood from the foregoing description, and it will be apparent that various changes may be made thereto without departing from the spirit and scope of the invention or sacrificing all of its material advantages, the examples hereinbefore described merely being preferred or exemplary embodiments of the invention.

What is claimed is:

1. A composite mold comprising:
a porous mold base comprising a first portion comprised of a sintered material formed by sintering noble metal particles and tungsten carbide particles, the first portion having a molding surface; and
a lubricant filled in the porous mold base.

2. The composite mold in accordance with claim 1, wherein a percentage by weight of the noble metal particles in the sintered material is in the range from 1% to 25%.

3. The composite mold in accordance with claim 2, wherein the percentage by weight of the noble metal particles in the sintered material is in the range from 1% to 13%.

4. The composite mold in accordance with claim 1, wherein the noble metal particles are comprised of a material selected from the group consisting of Pt, Re, PtₘRhₙ alloy, ReₓIr_{y} alloy, and PtₘIrₙ alloy particles; wherein, x is in the range from 0.25 to 0.55, y is in the range from 0.45 to 0.75, and m and n satisfy the following conditions: m+n=100, and 10<m<90.

5. The composite mold in accordance with claim 1, wherein the lubricant is selected from the group consisting of mineral oil, animal oil, and vegetable oil.

6. The composite mold in accordance with claim 1, wherein the porous mold base further comprises a second portion integrally formed with the first portion and located distal from the molding surface.

7. The composite mold in accordance with claim 6, wherein the second portion is made of a sintered material formed by sintering tungsten carbide particles.

8. A method for making a composite mold, comprising the steps of:
providing a first mold;
placing a mixture of noble metal particles and tungsten carbide particles into the first mold;
sintering the mixture so as to form a porous mold base having a molding surface; and
filling the porous mold base with a lubricant by immersing the porous mold base in the lubricant.

9. The method for making a composite mold in accordance with claim 8, wherein the first mold is made of a hard metallic alloy.

10. The method for making a composite mold in accordance with claim 8, wherein a percentage by weight of the noble metal particles in the mixture of noble metal particles and tungsten carbide particles is in the range from 1% to 25%.

11. The method for making a composite mold in accordance with claim 10, wherein the percentage by weight of the noble metal particles in the mixture of noble metal particles and tungsten carbide particles is in the range from 1% to 13%.

12. The method for making a composite mold in accordance with claim 10, wherein the noble metal particles are placed adjacent a surface of the first mold corresponding to the molding surface of the porous mold base.

13. A method for making a composite mold, comprising the steps of:
providing a first mold;
placing tungsten carbide particles into a second part of the first mold;
placing a mixture of noble metal particles and tungsten carbide particles into a first part of the first mold, the first part being adjacent the second part;
sintering the tungsten carbide particles and the mixture so as to form a porous mold base having a first portion and a second portion adjacent the first portion, the first portion comprising a molding surface distal from the second portion; and
filling the porous mold base with a lubricant by immersing the porous mold base in the lubricant.

14. The method for making a composite mold in accordance with claim 8, wherein a percentage by weight of the noble metal particles in the mixture of noble metal particles and tungsten carbide particles is in the range from 1% to 25%.

15. The method for making a composite mold in accordance with claim 10, wherein the percentage by weight of the noble metal particles in the mixture of noble metal particles and tungsten carbide particles is in the range from 1% to 13%.
